(19) United States
(12) Patent Application Publication
(10) Pub. No.: US 2013/0135901 A1
(43) Pub. Date: May 30, 2013

(54) ILLUMINATION DEVICE AND DISPLAY DEVICE

(71) Applicant: Yoshitake Ishimoto, Osaka-shi (JP)

(72) Inventor: Yoshitake Ishimoto, Osaka-shi (JP)

(73) Assignee: Sharp Kabushiki Kaisha, Osaka-shi, Osaka (JP)

(21) Appl. No.: 13/814,020

(22) PCT Filed: May 31, 2011
(86) PCT No.: PCT/JP2011/062447

§ 371 Date: Feb. 4, 2013

(30) Foreign Application Priority Data
Aug. 9, 2010 (JP) 2010-178326

(51) Int. Cl. G02B 6/24

(52) U.S. Cl. CPC G02B 6/24
USPC 362/617

(57) ABSTRACT

Disclosed is an illumination device that makes it possible to improve the efficiency of the work of processing light-guide panels. Said illumination device is provided with: a light-guide panel (23) contained in a back chassis (21); and pressure members (31) that hold the light-guide panel (23) by applying pressure thereto. There are a plurality of pressure members (31), and at least one pressure member (31) is disposed on each side face (23c to 23f) of the light-guide panel (23), individually applying pressure to each of said faces 823c to 23f).

### TECHNICAL FIELD

The present invention relates to illumination devices and display devices.

### BACKGROUND ART

In display devices of the type known as liquid crystal display devices, the liquid crystal display panel that displays an image is non-luminous; thus, an illumination device is provided at the rear face side of the liquid crystal display panel (at the side of the liquid crystal display panel opposite from its display face surface), and the liquid crystal display panel is illuminated with the light from the illumination device. The illumination device provided at the rear face side of the liquid crystal display panel is called, for example, a backlight unit.

Backlight units provided in liquid crystal display devices are roughly divided into a direct-lit type and an edge-lit type.

Each type is structured, in brief, as follows. In a direct-lit backlight unit, a light source is arranged immediately behind the liquid crystal display panel (in a space facing the rear face of the liquid crystal display panel). The light emitted from the light source illuminates the liquid crystal display panel through optical sheets (such as a differ sheet, a lens sheet, and a polarizer sheet).

On the other hand, in an edge-lit backlight unit, a light guide plate is arranged immediately behind the liquid crystal display panel, and a light source is arranged to face a predetermined side edge face of the light guide plate. The illuminating operation of an edge-lit backlight unit proceeds as follows. When the light source emits light, the light is introduced into the light guide plate through the predetermined side edge face thereof. The light introduced into the light guide plate is then repeatedly reflected internally so as to eventually exit from the light guide plate through the front face thereof (its face pointing to the liquid crystal display panel) as planar light and then illuminate the liquid crystal display panel through the optical sheets.

The two types of backlight units are chosen to suit the purpose. Liquid crystal display devices dedicated to slim products adopt edge-lit backlight units, because these are advantageous to slimming down.

In edge-lit backlight units, components such as a light guide plate and a light source are typically accommodated within an accommodation space inside a casing (accommodating container). Within the accommodation space, then, the light guide plate is held and positioned.

As a method of positioning the light guide plate, for example, according to one conventionally known method, positioning protuberances are formed on a casing, and positioning recesses in which to fit the positioning protuberances are formed in the light guide plate, so that the protuberances on the casing are fitted in the positioning recesses (see, for example, Patent Document 1 listed below).

According to another method, positioning pins are fitted within the accommodation space of the casing, and these positioning pins are fitted in positioning recesses in the light guide plate.

In either case, conventionally, some processing for positioning needs to be applied to the light guide plate.

### LIST OF CITATIONS

### Patent Literature

Patent Document 1: Japanese Patent Application Publication No. 2010-2745

### SUMMARY OF INVENTION

### Technical Problem

Certainly, positioning the light guide plate by the conventional methods mentioned above permits the light guide plate to be positioned satisfactorily; however, the processing of the light guide plate then requires an extra step of forming positioning recesses in the light guide plate. This increases the time required for the processing of the light guide plate. Thus, in cases where the light guide plate is positioned by the conventional methods, it is difficult to improve the efficiency of the processing of the light guide plate.

Devised against the background discussed above, the present invention aims to provide an illumination device and a display device that allow improvement of the efficiency of the processing of a light guide plate.

### Solution to Problem

To achieve the above aim, according to a first aspect of the invention, an illumination device is provided with: a casing; a light guide plate accommodated in a casing and having a front face pointing toward an illuminated body, a rear face opposite from the front face, and a plurality of side edge faces contiguous with the front and rear faces; and a pressing member for pressing and thereby holding the light guide plate. The pressing member includes a plurality of pressing members which are arranged at least one at each of the plurality of side edge faces of the light guide plate, and the plurality of side edge faces of the light guide plate are each pressed individually by the corresponding at least one of the pressing members.

In the illumination device according to the first aspect, as described above, in the structure where the light guide plate is held by being pressed by pressing members, at least one of the pressing members is arranged at each of the plurality of side edge faces of the light guide plate, and the plurality of side edge faces of the light guide plate are pressed individually by the pressing members, so that the light guide plate is held so as not to move (be displaced) in directions perpendicular to the thickness direction of the light guide plate; that is, the light guide plate is positioned in directions perpendicular to its thickness direction. This eliminates the need to separately provide positioning members for positioning the light guide plate in directions perpendicular to its thickness direction, and thus naturally eliminates the need to form in the light guide plate positioning recesses into which to fit those positioning members. The elimination of the need to form positioning recesses in the light guide plate shortens the processing time of the light guide plate accordingly, and this helps increase the efficiency of the processing of the light guide plate.

In the illumination device according to the first aspect, it is preferable that the pressing members be formed of an elastically deformable cushion material. With this structure, even when the light guide plate is expansion-deformed under the influence of heat, the expansion-deformation of the light guide plate can be absorbed by the pressing members, and thus there is no need to previously reserve gaps between the plurality of side edge faces of the light guide plate and the pressing members respectively. Moreover, when the plurality of side edge faces of the light guide plate are pressed by their respective pressing members, the pressing members are in an elastically deformed (compression-deformed) state; thus even if the light guide plate is contraction-deformed, the pressing members undeform so as not to produce gaps between the plurality of side edge faces of the light guide plate and the pressing members respectively. In this way, wobbling of the light guide plate is suppressed. That is, incomplete positioning of the light guide plate is prevented, and the efficiency of the processing of the light guide plate is improved.

In the illumination device according to the first aspect, it is preferable that two or more of the pressing members be arranged at each of the plurality of the side edge faces of the light guide plate. With this structure, the light guide plate can be held and positioned reliably.

In the illumination device according to the first aspect, it is preferable that the light guide plate have a rectangular exterior shape as seen in a plan view from the direction facing the front face of the light guide plate, and that two of the pressing members be arranged at each of the plurality of the side edge faces of the light guide plate such that four corner portions of the light guide plate as seen in a plan view are pressed by the pressing members. That is, it is preferable that two of the pressing members be arranged at the side of each of four corner portions of the light guide plate as seen in a plan view. With this structure, in a case where a light guide plate having a rectangular exterior shape as seen in plan view is used, the light guide plate can be held and positioned in a well-balanced fashion.

In the illumination device according to the first aspect, preferably, there may additionally be provided fixing members to which the pressing members are secured, and the fixing members may be fitted to the casing. With this structure, the pressing members can be fixed easily. Moreover, in a case where the pressing members need to be replaced for some reason, by removing the fixing members from the casing, the pressing members can be replaced easily.

In the illumination device according to the first aspect, the pressing members may be secured to the casing, or the pressing members may be secured to the light guide plate. With this structure, the pressing members can be fixed easily.

According to a second aspect of the invention, a display device is provided with: an illumination device according to the first aspect; and a display panel illuminated with the light from the illumination device.

With the display device structured as described above, it is possible to improve the efficiency of the processing of the light guide plate.

### Advantageous Effects of the Invention

As described above, according to the present invention, it is possible to obtain an illumination device and a display device that allow improvement of the efficiency of the processing of a light guide plate

### BRIEF DESCRIPTION OF DRAWINGS

FIG. 1 is an exploded perspective view of a display device incorporating an illumination device according to one embodiment of the invention (pressing members omitted);

FIG. 2 is a sectional view, on a magnified scale, of part (around a light source) of an illumination device according to one embodiment of the invention;

FIG. 3 is a plan view of an illumination device according to one embodiment of the invention as seen from the direction facing the front face of the light guide plate (optical sheets omitted);

FIG. 4 is a sectional view, on a magnified scale, of part (around a pressing member) of an illumination device according to one embodiment of the invention;

FIG. 5 is a perspective view of a pressing member in an illumination device according to one embodiment of the invention;

FIG. 6 is a sectional view, on a magnified scale, of part (around a pressing member) of an illumination device according to a modified example of the invention;

FIG. 7 is a diagram illustrating how pressing members are fixed in an illumination device according to a modified example of the invention;

FIG. 8 is a diagram illustrating how pressing members are fixed in an illumination device according to a modified example of the invention; and

FIG. 9 is a plan view of an illumination device according to a modified example of the invention as seen from the direction facing the front face of the light guide plate (optical sheets omitted).

### DESCRIPTION OF EMBODIMENTS

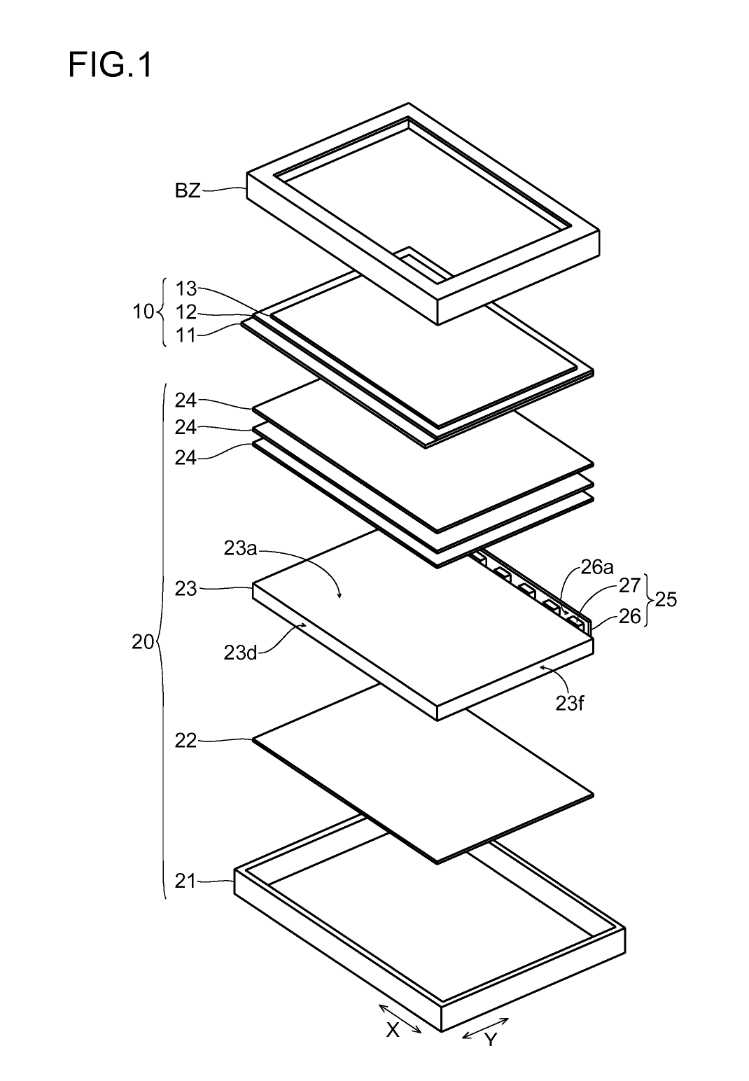

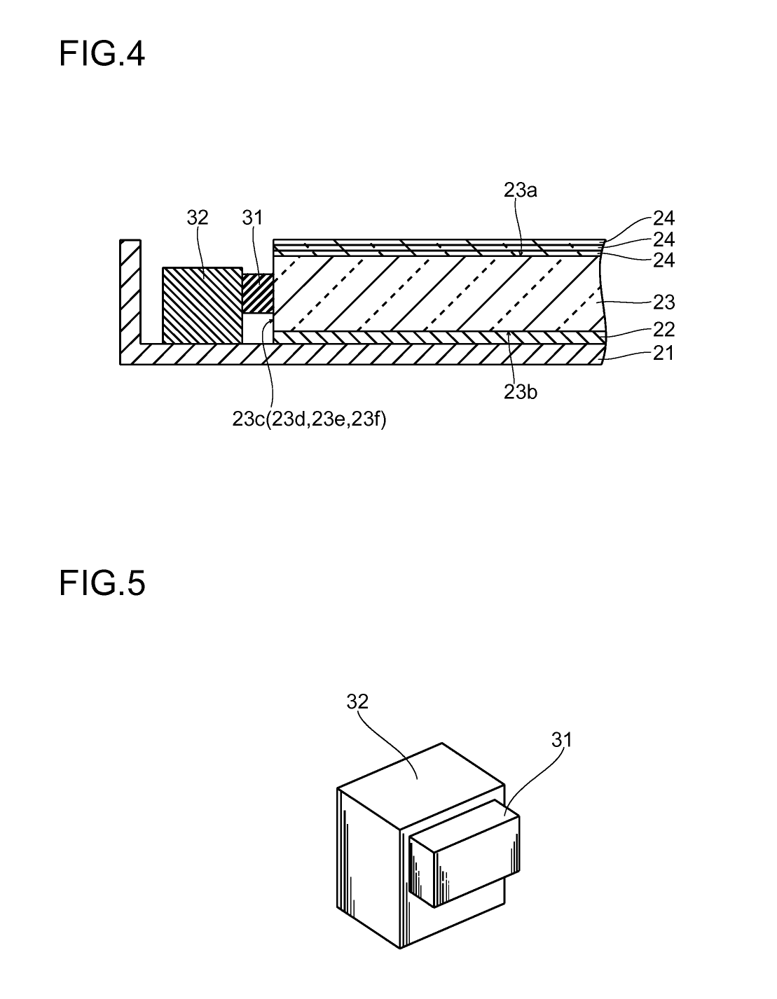

The structure of a display device incorporating an illumination device according to one embodiment of the present invention will be described below with reference to FIGS. 1 to 5.

The display device is a liquid crystal display device and, as shown in FIG. 1, at least includes a liquid crystal display panel 10 which displays an image and a backlight unit 20 which is provided at the rear face side of the liquid crystal display panel 10 opposite from its display face side. The liquid crystal display panel 10 is an example of an “illuminated body” and a “display panel” according to the invention. The backlight unit 20 is an example of an “illumination device” according to the invention.

The liquid crystal display device further includes a bezel BZ as a casing. The bezel BZ covers the liquid crystal display panel 10 and the backlight unit 20 from the display face side of the liquid crystal display panel 10.

The liquid crystal display panel 10 has a display area where an image is actually displayed and a non-display area which is the area outside the display area. In the display area of the liquid crystal display panel 10, a plurality of pixels arrayed in a matrix are fabricated.

The plurality of pixels are each driven via a switching device, a pixel electrode, a common electrode, etc. To avoid cluttering the drawings, however, no switching devices, pixel electrodes, or counter electrode are illustrated, and nor are any conductors or the like electrically connected to them.

The switching device comprises a TFT (thin-film transistor), with the gate of the switching device connected to a gate line (scanning line) and the source of the switching device connected to a source line (data line). To the drain of the switching device, a pixel electrode is connected, and opposite the pixel electrode, a common electrode is arranged. Between the pixel electrode and the common electrode, liquid crystal (not shown) is held. Switching devices are provided one for each of the pixels, and so are pixel electrodes. On the other hand, a single common electrode is, as its name suggests, common to all the pixels.

During display operation, based on a video signal, the optical property (light transmittance) of the liquid crystal is varied pixel-by-pixel. Specifically, in each pixel, a predetermined electric power is fed via the switching device to the pixel electrode so that an electric field is produced between the pixel electrode and the common electrode. The electric field produced between the pixel electrode and the common electrode changes the alignment of liquid crystal molecules and hence the transmittance with which light is transmitted through the liquid crystal.

Thus, when the backlight unit 20 emits backlight and the backlight illuminates the rear face of the liquid crystal display panel 10, the backlight is transmitted through the liquid crystal display panel 10 with varying transmittance from pixel to pixel. In this way, a desired image is displayed on the display face of the liquid crystal display panel 10.

Now, the structure of the liquid crystal display panel 10 and the backlight unit 20 will be described in more detail.

As shown in FIG. 1, the liquid crystal display panel 10 at least includes two transparent substrates 11 and 12. One transparent substrate 11 is called an active matrix substrate; the other transparent substrate 12 is often called a counter substrate because it is disposed opposite the transparent substrate 11 and is also called a color filter substrate.

On a predetermined face of one transparent substrate 11, switching devices and pixel electrodes are formed, and so are gate lines (scanning lines) and source lines (data lines) which are electrically connected to them. On a predetermined face of the other transparent substrate 12, a common electrode is formed. On the predetermined face of the other transparent substrate 12, in addition to the common electrode, color filters are also formed as necessary. The predetermined faces of the two transparent electrodes 11 and 12 are each covered with an alignment film (not shown) which can align liquid crystal molecules in a particular orientation.

The two transparent substrates 11 and 12 are bonded together with a sealing member (not shown) in between such that their respective predetermined faces face each other. Between the two transparent substrates 11 and 12, liquid crystal is sealed in. Thus, the liquid crystal is in a state held between the pixel electrodes and the common electrode (between the alignment film covering the predetermined face of one transparent substrate 11 and the alignment film covering the predetermined face of the other transparent electrode 12).

The two transparent substrates 11 and 12 are given different exterior sizes such that the exterior size of the transparent substrate 11 is larger than the exterior size of the transparent substrate 12. Accordingly, even though the two transparent substrates 11 and 12 are bonded together, an edge of the transparent substrate 11 does not coincide with an edge of the transparent substrate 12, leaving part of the predetermined face of the transparent substrate 11 exposed out of the transparent substrate 12. This exposed part of the predetermined face of the transparent substrate 11 is an area within the non-display area, and is used to electrically connect a driver (not shown) to the transparent substrate 11.

The faces of the two transparent substrates 11 and 12 opposite from their respective predetermined faces (liquid-crystal-side faces) are each laid with a polarizer sheet 13 which only transmits lightwaves oscillating in a particular direction. The two polarizer sheets 13 have their transmission axis directions displaced by 90 degrees from each other.

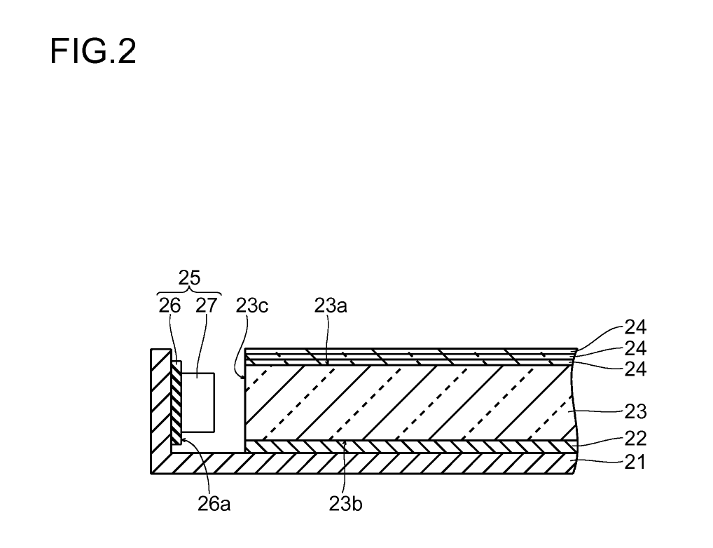

As shown in FIGS. 1 and 2, the backlight unit 20 provided at the rear face side of the liquid crystal display panel 10 is of an edge-lit type, and at least includes a back chassis 21, a reflective sheet 22, a light guide plate 23, an optical sheet 24, and a light source module 25. The back chassis 21 is an example of a “casing” according to the invention.

The back chassis 21 is formed substantially in the shape of a box that is open at the liquid crystal display panel 10 side. That is, the back chassis 21 has a bottom portion and a side portion erect from around the edge of the bottom portion. The space surrounded by the bottom and side portions of the back chassis 21 serves as an accommodation space, and inside this accommodation space of the back chassis 21 are accommodated the reflective sheet 22, the light guide plate 23, the optical sheet 24, and the light source module 25.

The reflective sheet 22 is placed on the inner surface of the bottom portion (the bottom face) of the back chassis 21. Thus, the reflective sheet 22 permits the inner surface of the bottom portion (the bottom face) of the back chassis 21 to serve as a light reflecting surface.

The light guide plate 23, when light from the light source module 25 is introduced into it, emits it toward the liquid crystal display panel 10. The light guide plate 23 has a front face 23a, a rear face 23b opposite from the front face 23a, and a plurality of side edge faces contiguous with the front and rear faces 23a and 23b. The light guide plate 23 is placed on the inner surface of the bottom portion (the bottom face) of the back chassis 21 with the reflective sheet 22 in between. The front face 23a of the light guide plate 23 points to the liquid crystal display panel 10, and the rear face 23b of the light guide plate 23 points to the bottom portion of the back chassis 21.

Thus, the front face 23a of the light guide plate 23 serves as a light exit face through which the light introduced into the light guide plate 23 (the light from the light source module 25) is emitted toward the liquid crystal display panel 10. On the other hand, the rear face 23b of the light guide plate 23 does not serve as a light exit face because it is covered by the reflective sheet 22.

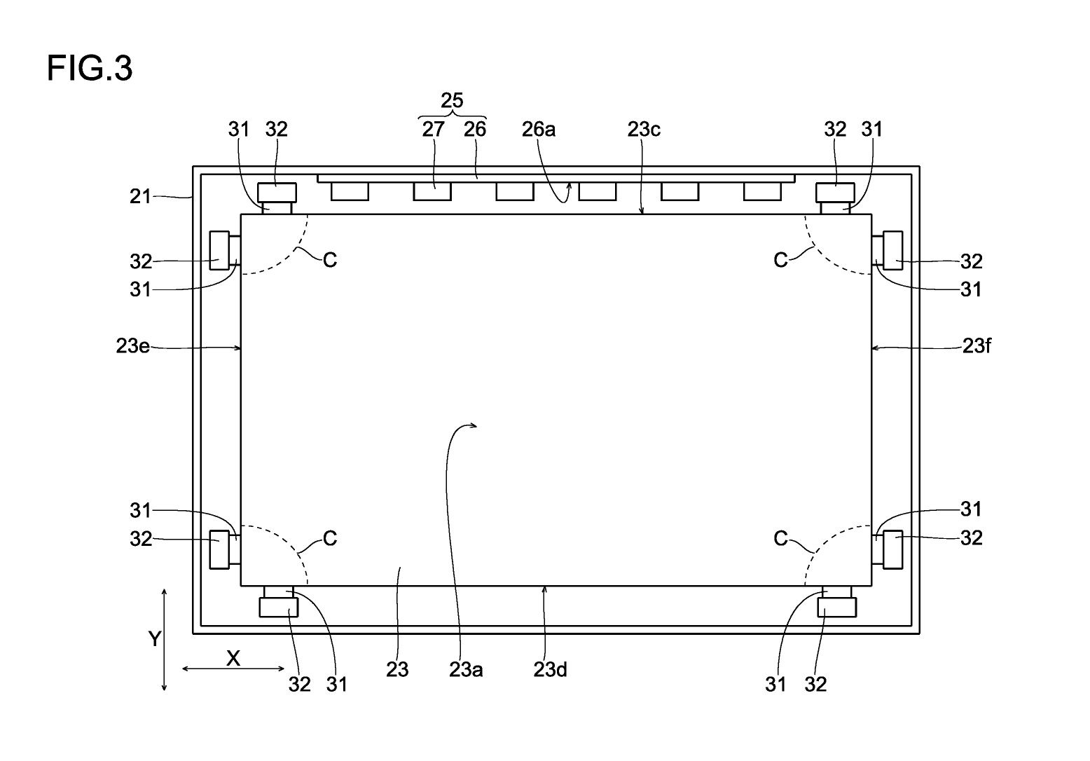

As seen in a plan view (see FIG. 3) from the direction facing the front face 23a of the light guide plate 23, the exterior shape of the light guide plate 23 (the shape of the front and rear faces 23a and 23b as seen in a plan view) is rectangular without any protrusions or recesses. That is, the light guide plate 23 has four side edge faces 23c to 23f each formed as a flat surface (a substantially flat surface having no intentionally formed protrusions or recesses). Of the four side edge faces 23c to 23f, the side edge face 23c serves as a light entrance face which is struck by the light from the light source module 25. Thus, through the side edge face 23c of the light guide plate 23, the light from the light source module 25 is introduced into the light guide plate 23.

The side edge faces 23c and 23d of the light guide plate 23 are faces that point in opposite directions and that are parallel to the longer-side direction (X direction) of the light guide plate 23 as seen in a plan view. Likewise, the side edge faces 23e and 23f of the light guide plate 23 are faces that point in opposite directions and that are parallel to the shorter-side direction (Y direction) of the light guide plate 23 as seen in a plan view.

The optical sheet 24 shown in FIGS. 1 and 2 includes a diffuser sheet, a lens sheet, etc., and is placed on the front face (light exit face) 23a of the light guide plate 23. The optical sheet 24 thus diffuses, condenses, and otherwise modifies the light emanating from the front face (light exit face) 23a of the light guide plate 23.

The light source module 25 generates the light (the light introduced into the light guide plate 23) from which backlight is produced, and is arranged at the side edge face 23c (light entrance face) of the light guide plate 23. There is no particular restriction on the number of light source modules 25 used. For example, though not illustrated, another light source module 25 may be added and arranged at the side edge face 23d of the light guide plate 23. In other words, in addition to the side edge face 23c of the light guide plate 23, the side edge face 23d may also be made to function as a light entrance face.

The light source module 25 has a structure in which a plurality of LEDs 27 are mounted on the mounting face 26a of a single printed circuit board 26. There is no particular restriction on the number of LEDs 27 mounted, which may therefore be changed to suit the purpose.

The printed circuit board 26 comprises, for example, an FPC (flexible printed circuit board) formed in the shape of a strip, and is held with its mounting face 26a facing the side edge face 23c (light entrance face) of the light guide plate 23. Accordingly, the LEDs 27 mounted on the mounting face 26a of the printed circuit board 26 too face the side edge face 23c (light entrance face) of the light guide plate 23. Thus, when the LEDs 27 emit light, the light strikes the side edge face 23c (light entrance face) of the light guide plate 23 and is therethrough introduced into the light guide plate 23.

The LEDs 27 are white LEDs, for example those in which a phosphor (fluorescent or phosphorescent substance) that converts blue (blue-violet) LED light into yellow light is combined with a blue LED (blue-violet LED). The LEDs 27 may instead be those in which a phosphor that converts blue (blue-violet) LED light into green and red light is combined with a blue LED (blue-violet LED), or those in which three types of LEDs, namely blue, green, and red LEDs, are combined together.

For the light from the light source module 25 to efficiently strike the side edge face 23c (light entrance face) of the light guide plate 23, the light guide plate 23 needs to be positioned accurately within the accommodation space of the back chassis 21.

Accordingly, in this embodiment, as shown in FIG. 3, pressing members 31 which are separate members from the back chassis 21 are, along with the light guide plate 23, accommodated within the accommodation space of the back chassis 21, and by use of the pressing members 31, the light guide plate 23 is positioned accurately within the accommodation space of the back chassis 21. For the sake of simple illustration, the pressing members 31 are not shown in FIG. 1.

Eight of the pressing members 31 are used, and these pressing members 31 are arranged two-by-two at each of the four side edge faces 23c to 23f of the light guide plate 23.

Specifically, the pressing members 31 are arranged as follows. The two pressing members 31 located at the side edge face 23c (light entrance face) of the light guide plate 23 are arranged to face one and the other end portions, respectively, of the side edge face 23c (light entrance face) of the light guide plate 23 in the X direction so as not to intercept the light traveling from the light source module 25 to the side edge face (light entrance face) 23c of the light guide plate 23 (so as to avoid the region where the light source module 25 is arranged). Likewise, the two pressing members 31 located at the side edge face 23d of the light guide plate 23 are arranged to face one and the other end portions, respectively, of the side edge face 23d of the light guide plate 23 in the X direction.

On the other hand, the two pressing members 31 located at the side edge face 23e of the light guide plate 23 are arranged to face one and the other end portions, respectively, of the side edge face 23e of the light guide plate 23 in the Y direction. Likewise, the two pressing members 31 located at the side edge face 23f of the light guide plate 23 are arranged to face one and the other end portions, respectively, of the side edge face 23f of the light guide plate 23 in the Y direction.

These pressing members 31 press the four side edge faces 23c to 23f of the light guide plate 23 respectively. In other words, in this embodiment, a light guide plate 23 having four side edge faces 23c to 23f is used, and all of the four side edge faces 23c to 23f of this light guide plate 23 are pressed by the pressing members 31.

Specifically, the side edge face 23c of the light guide plate 23 is pressed by the pressing members 31 in one direction along the Y direction (in the direction from the side edge face 23c to the side edge face 23d), and the side edge face 23d of the light guide plate 23 is pressed by the pressing members 31 in the direction opposite from the one direction along the Y direction (in the direction from the side edge face 23d to the side edge face 23c). On the other hand, the side edge face 23e of the light guide plate 23 is pressed by the pressing members 31 in one direction along the X direction (in the direction from the side edge face 23e to the side edge face 23f), and the side edge face 23f of the light guide plate 23 is pressed by the pressing members 31 in the direction opposite from the one direction along the X direction (in the direction from the side edge face 23f to the side edge face 23e),

Thus, the side edge faces 23c and 23d of the light guide plate 23 are in a state pressed in opposite directions by the pressing members 31, and in addition the side edge faces 23e and 23f of the light guide plate 23 are in a state pressed in opposite directions by the pressing members 31, and in this way the light guide plate 23 is held so as not to move in either the X or Y direction. That is, the light guide plate 23 is positioned in the X and Y directions. As seen in a plan view from the direction facing the front face 23a of the light guide plate 23, four corner portions (parts indicated by broken lines in FIG. 3) C of the light guide plate 23 are in a state pressed by the pressing members 32.

Specifically, the pressing members 31 are structured as members formed of an elastically deformable cushion material. The cushion material of which the pressing members 31 are formed is, for example, urethane or sponge.

Moreover, as shown in FIGS. 3 to 5, the pressing members 31 are secured to fixing members 32 respectively. The fixing members 32 are resin blocks substantially in the shape of a rectangular parallelepiped, and are formed of polycarbonate resin, polystyrene resin, ABS (acrylonitrile-butadiene-styrene) resin, or the like. The pressing members 31 are secured to the fixing members 32, and the fixing members 32 are fitted to the bottom portion of the back chassis 21, so that the pressing members 31 are fixed within the accommodation space of the back chassis 21.

The positions at which the pressing members 31 are secured to the fixing members 32 are such that the pressing members 31 are held between the fixing members 32 and the side edge faces 23c (23d to 23f) of the light guide plate 23. When the pressing members 31 are pressing the side edge faces 23c (23d to 23f) of the light guide plate 23, the pressing members 31 are elastically deformed (compression-deformed). That is, the pressing members 31 exert a biasing force that presses the side edge faces 23c (23d to 23f) of the light guide plate 23.

There is no restriction on how the fixing members 32 are fitted to the bottom portion of the back chassis 21. For example, though not shown, the fixing members 32 may be fastened to the bottom portion of the back chassis 21 with screws. Or engagement portions may be formed integrally with the fixing members 32 so that the engagement portions of the fixing members 32 are engaged with the bottom portion of the back chassis 21.

In this embodiment, as described above, owing to at least one pressing member 31 being arranged at each of the four side edge faces 23c to 23f of the light guide plate 23 and thus the four side edge faces 23c to 23f of the light guide plate 23 being pressed individually by their respective pressing members 31, the light guide plate 23 is held so as not to move (be displaced) in directions (X and Y directions) perpendicular to the thickness direction of the light guide plate 23; that is, the light guide plate 23 is positioned in the X and Y directions. This eliminates the need to separately provide positioning members for positioning the light guide plate 23 in the X and Y directions, and thus naturally eliminates the need to form in the light guide plate 23 positioning recesses into which to fit those positioning members. The elimination of the need to form positioning recesses in the light guide plate 23 shortens the processing time of the light guide plate 23 accordingly, and this helps increase the efficiency of the processing of the light guide plate 23.

In this embodiment, as described above, owing to the use of an elastically deformable cushion material as the material of the pressing members 31, even when the light guide plate 23 is expansion-deformed under the influence of heat, the expansion-deformation of the light guide plate 23 can be absorbed by the pressing members 31, and thus there is no need to previously reserve gaps between the four side edge faces 23c to 23f of the light guide plate 23 and the pressing members 31 respectively. Moreover, when the four side edge faces 23c to 23f of the light guide plate 23 are pressed by their respective pressing members 31, the pressing members 31 are in an elastically deformed (compression-deformed) state; thus even if the light guide plate 23 is contraction-deformed, the pressing members 31 undeform so as not to produce gaps between the four side edge faces 23c to 23f of the light guide plate 23 and the pressing members 31 respectively. In this way, wobbling of the light guide plate 23 is suppressed. That is, incomplete positioning of the light guide plate 23 is prevented, and the efficiency of the processing of the light guide plate 23 is improved.

In this embodiment, as described above, owing to the pressing members 31 being arranged two-by-two at each of the four side edge faces 23c to 23f of the light guide plate 23, the light guide plate 23 can be held and positioned reliably. Moreover, in this embodiment, owing to the four corner portions C of the light guide plate 23 being in a state pressed by the pressing members 31, the light guide plate 23 is held and positioned in a well-balanced fashion.

In this embodiment, as described above, by securing the pressing members 31 to the fixing members 32, and then fitting the fixing members 32 to the bottom portion of the back chassis 21, the pressing members 31 can be fixed easily. Moreover, in a case where the pressing members 31 need to be replaced for some reason, by removing the fixing members 32 from the bottom portion of the back chassis 21, the pressing members 31 can be replaced easily.

It should be understood that the embodiment presented herein is in every aspect illustrative and not restrictive. The scope of the present invention is defined not by the description of the embodiment given above but by the appended claims, and encompasses any modifications and variations made within the scope and spirit equivalent to those of the claims.

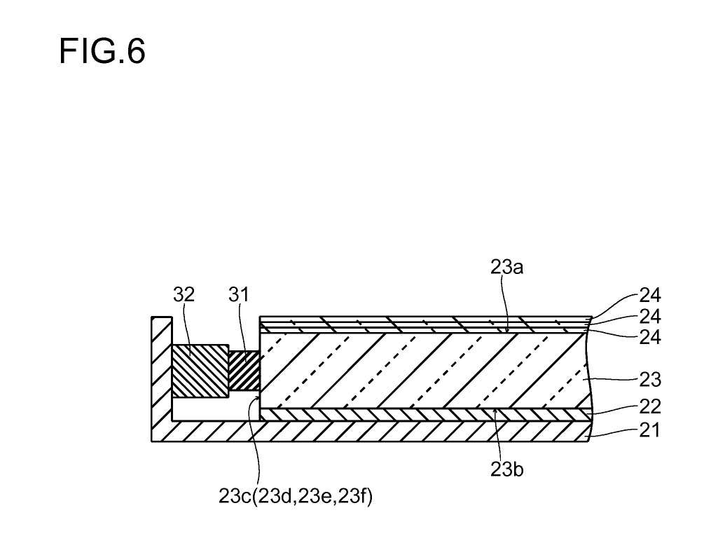

For example, although the embodiment presented above deals with a case where the pressing members 31 are secured to the fixing members 32 and the fixing members 32 are fitted to the bottom portion of the back chassis 21, this is not meant to limit the invention; instead, as shown in FIG. 6, fixing members 32 having pressing members 31 secured to them may be fitted to a side portion of the back chassis 21. In that case, the fitting of the fixing members 32 to the side portion of the back chassis 21 can be achieved by a method similar to that used in the case where the fixing members 32 are fitted to the bottom portion of the back chassis 21.

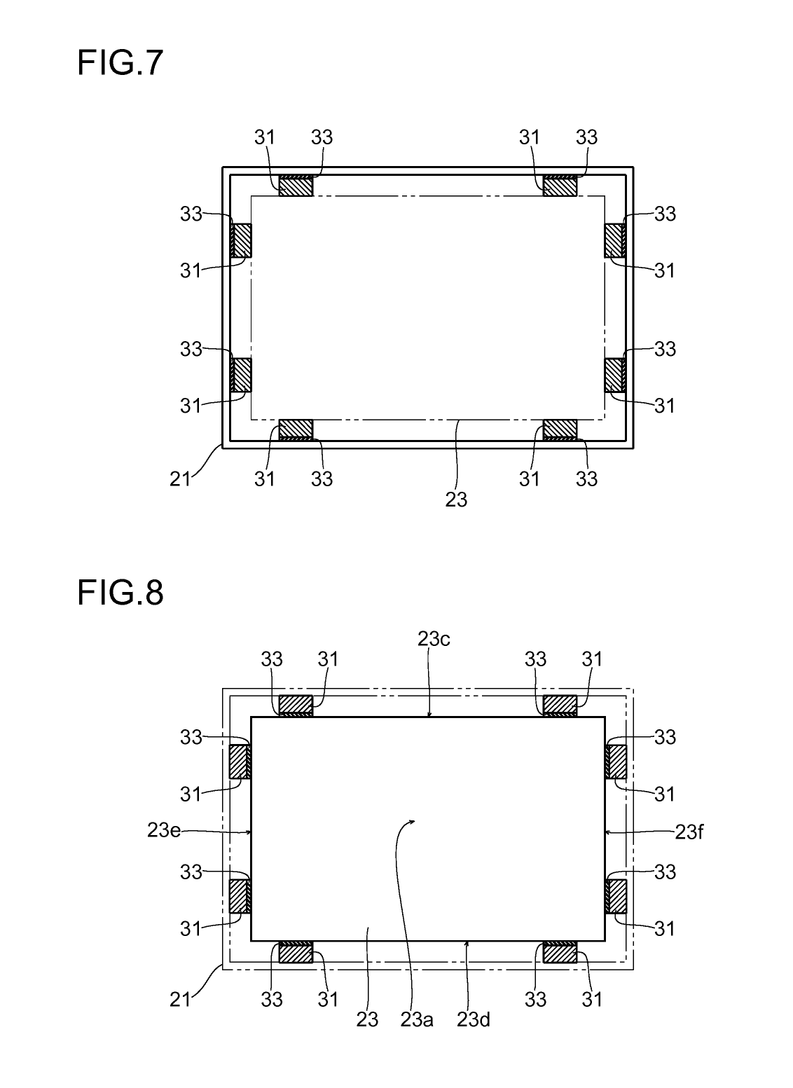

As shown in FIG. 7, the fixing member 32 may be omitted, and the pressing members 31 may be secured to a side portion of the back chassis 21. That is, a side portion of the back chassis 21 may be made to function as fixing members 32. This eliminates the need to reserve space for fitting the fixing members 32 within the accommodation space of the back chassis 21. This helps reduce the exterior size of the back chassis 21, and thus helps make the backlight unit 20 compact. The securing of the pressing members 31 to the side portion of the back chassis 21 can be achieved by use of adhesive members 33 of any appropriate kind.

As shown in FIG. 8, the pressing members 31 may be secured to the four side edge faces 23c to 23f of the light guide plate 23 respectively. In that case, by keeping the non-secured faces of the pressing members 31 opposite from their secured faces in contact with a side portion of the back chassis 21, it is possible to obtain the same effect as with the embodiment presented above.

Although the embodiment presented above deals with a case where the pressing members 31 are arranged two-by-two at each of the four side edge faces 23c to 23f of the light guide plate 23, this is not meant to limit the invention; instead, the pressing members 31 may be arranged one-by-one, or three-by-three or more, at each of the four side edge faces 23c to 23f of the light guide plate 23. Even varying numbers of pressing members 31 may be arranged at each of the four side edge faces 23c to 23f of the light guide plate 23.

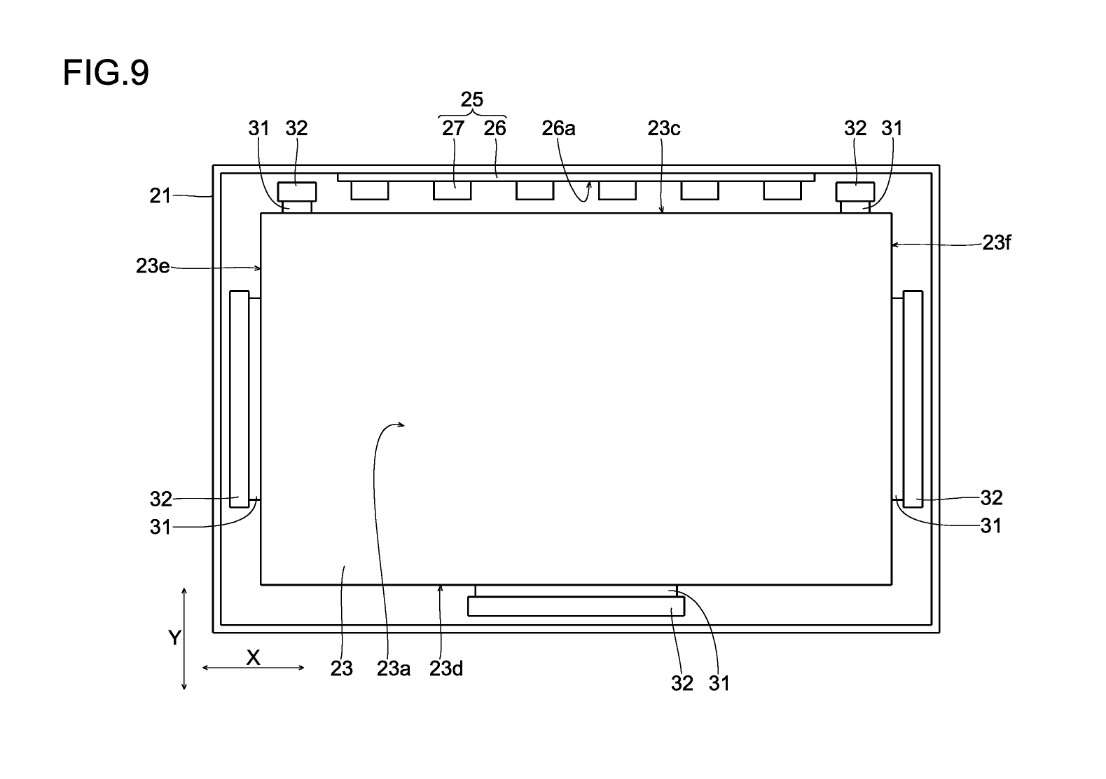

For example, as shown in FIG. 9, the pressing members 31 may be distributed around the four side edge faces 23c to 23f of the light guide plate 23 such that two pressing members 31 are arranged at the side edge face 23c (light entrance face), that one pressing member 31 elongate in the X direction is arranged at the side edge face 23d, and that pressing members 31 elongate in the Y direction are arranged one at each of the side edge faces 23e and 23f.

Although the embodiment presented above deals with a case where LEDs 27 are used as a light source of the backlight unit 20, this is not meant to limit the invention; instead, a cold-cathode tube or the like may be used as a light source of the backlight unit 20.

Although the embodiment presented above deals with a case where the present invention is applied to a liquid crystal display device, this is not meant to limit the invention; the present invention may be applied to any display devices other than liquid crystal display devices.

### LIST OF REFERENCE SIGNS

10 liquid crystal display panel (display panel)

20 backlight unit (illumination device)

21 back chassis (casing)

23 light guide plate

23a front face

23b rear face

23c, 23d, 23e, 23f side edge face

31 pressing member

32 fixing member

c corner portion

1. An illumination device comprising:
a casing;
a light guide plate accommodated in the casing and having
a front face pointing toward an illuminated body,
a rear face opposite from the front face, and
a plurality of side edge faces contiguous with the front and rear faces; and
a pressing member for pressing and thereby holding the light guide plate, wherein
the pressing member comprises a plurality of pressing members which are arranged at least one at each of the plurality of side edge faces of the light guide plate, and
the plurality of side edge faces of the light guide plate are each pressed individually by the corresponding at least one of the pressing members.

2. The illumination device according to claim 1, wherein the pressing members are formed of an elastically deformable cushion material.

3. The illumination device according to claim 1, wherein two or more of the pressing members are arranged at each of the plurality of the side edge faces of the light guide plate.

4. The illumination device according to claim 1, wherein
the light guide plate has a rectangular exterior shape as seen in a plan view from a direction facing the front face of the light guide plate, and
two of the pressing members are arranged at each of the plurality of the side edge faces of the light guide plate such that four corner portions of the light guide plate as seen in a plan view are pressed by the pressing members.

5. The illumination device according to claim 1, further comprising fixing members to which the pressing members are secured, wherein
the fixing members are fitted to the casing.

6. The illumination device according to claim 1, wherein the pressing members are secured to the casing.

7. The illumination device according to claim 1, wherein the pressing members are secured to the light guide plate.

8. A display device comprising:
an illumination device according to claim 1; and
a display panel illuminated with light from the illumination device.
